(19) United States
(12) Patent Application Publication
(10) Pub. No.: US 2017/0107384 A1
(43) Pub. Date: Apr. 20, 2017

(54) Synergistic Mixed Solvents-based Compositions to Improve Efficiency of Performance and Environmental Safety Using Commercial High Volatile Compositions Used for Removal of Paint, Varnish and Stain Coatings

(71) Applicant: KOLAZI S. NARAYANAN, WAYNE, NJ (US)

(72) Inventor: KOLAZI S. NARAYANAN, WAYNE, NJ (US)

(21) Appl. No.: 14/885,996

(22) Filed: Oct. 17, 2015

(51) Int. Cl. C09D 9/00; C09D 9/04

(52) U.S. Cl. CPC C09D 9/005; C09D 9/04

(57) ABSTRACT

A composition which is particularly effective for removing paint or varnish from wood concrete or metal surfaces comprising greater than about 40% by weight of a first volatile component comprising a volatile compound and a second non-volatile component comprising from about 20 to 80% by weight of a polar solvent selected from the group consisting of (pentanoic acid, 5-(dimethylamino)-4-methyl-5-oxo-methyl ester; propylene carbonate. N,N-dimethyl imidazolidinone, dimethyl sulfoxide, dimethyl acetamide, N-methyl pyrrolidone, gamma butyrolactone and mixtures thereof and an aqueous system additive. Methods for used of the composition are also disclosed.

### CROSS REFERENCE TO RELATED APPLICATIONS

This application is a continuation-in-part of U.S. patent application Ser. No. 14/805,332, filed Jul. 21, 2015, entitled Mixed Solvent Based Compositions for Removal of Paint and Varnish and a continuation-in-part of U.S. patent application Ser. No. 14/830,436, filed Aug. 19, 2015 entitled Improved Synergistic Mixed Solvents-Based Compositions For Removal Of Paint, Varnish And Stain Coatings, the entire contents of each of which is hereby incorporated by reference.

### BACKGROUND OF THE INVENTION

1. Field of the Invention

This invention relates to improving performance efficacy of non-aqueous paint and varnish remover compositions containing volatile components, and more particularly, by addition of pre-optimized solvent based compositions. Optimized solvent based compositions consist of mixed polar solvents and an activator. The activator can be either the volatile components or optionally lower boiling ethoxylated esters like ethoxy ethyl propionate (EEP). The pre-optimized compositions are described in applications Ser. Nos. 14/805,332 and 14/830,436, referred to hereinabove.

There are several paint stripping compositions in commercial use containing high amounts of volatile solvents. As used herein, the term “volatile solvent” means a solvent having a boiling points of less than 90° C. at atmospheric pressure or a vapor pressure greater than 70 mm of mercury at 25° C.

Some examples are: Methylene Chloride, Methanol, Ethanol, Isopropanol, Acetone, Methylethyl Ketone, and aliphatic hydrocarbon containing up to six carbon atoms.

Although known paint stripping compositions containing high levels of volatile components greater than 40% and, in some cases, greater than 70% have cost advantages and are effective in removing paints and varnish, they have certain major disadvantages. These disadvantages include high inhalation toxicity for the users, the presence of suspect carcinogens, high flammability, deficiency of oxygen when used in low ventilated surroundings, and leakage via vapor loss from defective containers. In addition, the use of certain of these volatile compounds, e.g., methylene chloride, is highly regulated by environmental agencies around the world. These compounds also often exhibit redeposition of the removed paint from the substrate during the paint striping process requiring retreatment. This, in turn, requires the need for to use larger amounts of the volatile paint stripping compositions measured by weight of the formulation/unit area of the treated substrate compared to the use of compositions containing compounds having low volatility, i.e., a boiling point of greater than 90° C. at atmospheric pressure or a vapor pressure greater than 70mm of mercury at 25° C., It is an object of this invention to reduce the exposure level and the effective use level of the volatile components by adding adequate amount of pre-optimized solvent based compositions.

2. Description of the Prior Art

The term “varnish and paint remove” as applied herein refers to chemical compositions which can strip or facilitate stripping of coatings, such as, paint, varnish, lacquer, shellac, polyurethane finishes and enamels, used to protect substrates such as wood and metal and to beautify them. Methylene chloride paint strippers are currently the industry standard for stripper performance. Methylene chloride strippers are effective for quickly softening most types of paints. T he speed at which methylene chloride performs is believed to be due to its high solvent power coupled with high volatility as reflected by its, extremely fast evaporation rate. This high volatility shortens the work life of methylene chloride paint strippers. Frequently, when methylene chloride paint strippers are used on thick accumulations of paint, more than one application is required since the work life is insufficient to permit penetration through the accumulation of paint. Methylene chloride is a chlorinated solvent which is closely regulated for environmental protection. Recently. it was discovered that methylene chloride can cause tumors in rats and mice. Since that discovery, the wide use of that solvent by industry and consumers has come under close scrutiny by federal regulatory agencies, N-methyl-2-pyrrolidone (NMP) has been employed in place of methylene chloride as the active ingredient in paint stripper compositions, Nelson, in U.S. Pat. No. 4,759,510, (Incorporated herein by reference in its entirety) for example, described a composition for this use having low volatility which included about 20% to 90% by weight of NMP and 30% to 70% by weight of an aromatic hydrocarbon solvent.

Mixtures of NMP and gamma-butyrolactone (BLO) also have been used as liquid formulations for removing screen printing inks. Madsen, in U.S. Pat. No. 4,836,950 (Incorporated herein by reference in its entirety), for example, described a liquid composition which included 1-25% by volume of NMP and/or BLO. Valasek, similarly, in U.S. Pat. No. 4,664,721(Incorporated herein by reference in its entirety), described a composition which included 30-85% by weight of NMP and 10-35% by weight of an oxygenated solvent selected from esters and ethers. BLO was mentioned as a suitable component (lactone), although butoxyethanol and cyclohexanone were preferred. Caster, in U.S. Pat. No. 4,865,758 (Incorporated herein by reference in its entirety) described a method of removing paint with a lower alkyl substituted 2-oxazolidinone. In comparative results reported therein, it was disclosed that ethyl 3-ethoxypropionate had no effect on paint removal. McCullins, in British 1,487,737, described a paint remover composition for aerosol type paints in the form of a gel which included methyl ethyl ketone, ethyl acetate, ethoxyethanol and 2-ethoxyethyl acetate. This mixture of solvents was considered effective for paint sprayed graffiti as a viscous, transparent gel containing particles of silica or alumina in suspension. Palmer, in U.S. Pat. No. 4,120,810, (Incorporated herein by reference in its entirety) described paint remover compositions of NMP and/or BLO, and at least 35 mole % of blends of alkyl naphthalenes and alkyl benzenes.
These and other compositions, however, have not proven particularly effective for removing paint and varnish from wood and metal surfaces, without containing objectionable halogenated or aromatic compounds. Furthermore, they do not possess the attributes of being biodegradable, non-flammable, having a low vapor pressure and low toxicity.
Narayanan et al in U.S. Pat. No 5,098,592 (Incorporated herein by reference in its entirety) (World patent No 5217640) have shown that a synergistic combination of NMP, BLO and ethyl 3-ethoxypropionate (EEP) is a very effective composition for removing varnish and several type of paints from wood and metal substrates.

In Narayanan et al in U.S. Pat. No. 5,154,848 (Incorporated herein by reference in its entirety). A composition in which NMP and/or BLO is replaced by components Polar solvents having Hansen's solubility parameter greater than 0.15 or 15%, preferably greater than 0.25 or 25%, more preferably greater than 0.35 or 35%. The solvent composition should have at least one solvent having Hansen's polar component greater than 0.25 or 25%. The component solvents have low volatility having boiling point greater than 120° C. at atmospheric pressure. Examples of such solvents are but not limited to are : Pentanoic acid, 5-(dimethylamino)-4-methyl-5-oxo-methyl ester: propylene carbonate; N,N-dimethyl imidazolidinone (DMI); Dimethyl Sulfoxide (DMSO); and Dimethyl acetamide (DMF).
A composition in which NMP and/or BLO is replaced by the above listed solvents.
Fusiak in U.S. Pat. No. 5,334,331 (Incorporated herein by reference in its entirety) describes compositions of NMP/BLO and combinations activated by cyclornethacone at around 5% to remove organic coatings from substrate
Fusiak et al in U.S. Pat. No. 5,049,300 (Incorporated herein by reference in its entirety) describes activation of NMP and combinations with acids
Known art of solvent based compositions for removal of paint, varnish coatings are non-aqueous, essentially free from water.
Several water based cleaning and spray compositions use powerful wetting agents and spreading agents. See: Robert Login et al on NOP use in multipurpose applications described in, WP 88/00184, U.S. Pat. No. 5,294,644(Incorporated herein by reference in its entirety) and U.S. Pat. No. 5,093,031 (Incorporated herein by reference in its entirety). Narayanan et al on synergy between NOP and Silwett L 77 (ethoxylated silicone) described in U.S. Pat. No. 5,508,249 (Incorporated herein by reference in its entirety), Rosen et al synergy between NOP and Alcohol ethoxylate, in U.S. Pat. No. 7,264,885 (Incorporated herein by reference in its entirety) and Narayanan et al (water dilutable NOP, alcohol ethoxylate synergistic composition. Easy wet 20) in U.S. Pat. No. 6,967,190 (Incorporated herein by reference in its entirety

### SUMMARY OF THE INVENTION

I have discovered a composition for removal of paint and varnish coating from wood, concrete or metal which is highly effective and avoids or reduces the detrimental environmental and toxicity problems heretofore encountered with stripping compositions. More particularly, this is achieved with a composition containing about 40% of a volatile component comprising a volatile compound as defined hereinabove and a non-volatile component comprising a polar solvent and an aqueous system wetting or spreading additive. Other optional compositions such as rheology modifiers, fragrance, bittering agents, emulsifiers can be added as needed.

A method is provided herein which is particularly effective for removing or stripping varnish and paint or stains from surfaces such as wood, or metal wherein the above described inventive composition is applied to a surface having a varnish, paint or stain thereon in an amount effective to wet or spread the coating, allowing the composition to remain on the surface for a time sufficient to loosen the coating and then removing the composition and coating from the surface. In a preferred method, the volatile and non-volatile components are admixed together just prior to applying the composition to the surface.

A preferred non-volatile component of he inventive composition comprises about 20-70% N-methyl-2-pyrrolidone, 30-80% gamma-butyrolactone and 1-30% EEP, 0.1-10% N-octyl pyrrolidone (NOP) and 0.1-5% Silwett L 77 (Ethoxylated siloxane), preferably 30-65% NMP, 35-70% BLO and 2-15% EEP, 0.2-5% NOP and 0.2-3% Silwet L 77and optimally, 35-39% NMP, 55-59% BLO and 3-5% EEP and 1-3% NOP and 0.5-2% Silwet L 77.

It is the object of this invention to enhance performance of essentially non-aqueous synergistic solvent mix to remove paint, varnish, and stain coatings from substrates. This objective is accomplished by including very effective wetting and spreading agents normally used for aqueous systems in small concentrations. These and other objects and features of the invention will be made apparent from the following description of the invention.

The choice of wetting and spreading components have, the following criteria.
1. Solvent-surfactant in one product
2. Estimated or measured HLB less than 8, preferably less than 6
3. Efficient wetting demonstrated by Drave's wetting of cotton skein with less than 5 seconds at 0.1% in water.
4. Equilibrium surface tension less than 30 mN/M (dynes/cm) at 0.1% in water
5. Contact angle in Teflon at less than 50° with 0.1% aqueous solution
6. Solvent action on most adhesive polymers
7. Total compatibility with the pre-evaluated synergistic solvent matrix
8. Water washable on dilution
9. Desirable synergy with the chosen spreading agent
10. Spreading agent low equilibrium surface tension as above
11. Contact angle as above
12. Synergy with the chosen wetting gent
13. Water washable on dilution
14. Total compatibility with the pre-evaluated synergistic solvent matrix

The advantage of including the inventive wetting agent and/or spreading agents along with essentially non-aqueous solvent matrix is to provide efficient spreading and wetting through the pores of the coated substrates and improve speed and completeness of the coating removal. Inclusion of the inventive components would also provide efficient removal of residual solvent matrix from the substrate during the post stripping washing process.

The Inventive compositions enable:
High lifting capability of varnish/paint type coating from substrates individually or along with commercial paint stripping compositions
Easy post-stripping washability for efficient removal of the inventive components from the substrate using water or common cleaning solvents like lower alcohols like ethanol, isopropanol (methanol will work but has environmental issues)

Typical such wetting and spreading agents but not limited to are described below: NOP, Alcoxylated (ethoxylated or propoxylated long alkyl chain (>C8 preferably >C10) alcohol, Alcoxylated silicone (ethoxylated siloxane). Following illustrations make use of N— Octyl pyrrolidone (NOP); Nonynol ethoxylate with average 3 EO; Silwett L 77 and combinations theeof.

### DETAILED DESCRIPTION OF THE INVENTION

Typical non-volatile components of paint and varnish remover compositions of the present invention include the following components.

TABLE 1
Typical Paint Stripping Compositions, Wt % (NEW)

| | Solvents | | | | |
|---|---|---|---|---|---|
| | Polar | Polar | Activator | | SPREADING |
| | Solvent | Solvent | (EEP) | WETTING | AGENT |
| | NMP/BLO/ | NMP/BLO/ | or safe | AGENT | (Silwett |
| | A through E | A through E | penetrant | (NOP)/(ALCEO)* | L 77)** |
| Essential | 20-80 | 10-90 | 1-20 | 0.1-10 | 0.1-5 |
| Suitable | 30-70 | 20-70 | 2-15 | 0.2-5 | 0.2-4 |
| Optimum | 40-60 | 30-40 | 1-5 | 0.5-3 | 0.5-3 |
| Preferred | 50-55 | 32-38 | 1-4 | 1-1.5 | 0.5-1 |

A commercial optimized wetting composition Easy wet 20 can also be used in the place of wetting agent
*Ethoxylated (3 EO) nonynol,
**Ethoxylated siloxane

Third solvent from NMP/BLO/A through E can also be added at (0-30%) by weight

Other Co— solvent and activators combinations as defined in copending application referred to hereinabove would also work. Acids/Bases/silicones can also be used as additional activators.

Optional suitable components (% by Wt.) Optimum Preferred are shown below:

TABLE 2
Optional Suitable Components, Wt %

| Components | Optimum | Preferred |
|---|---|---|
| Surfactants | 0-5 | 2-3 |
| Organic acid | 0-5 | 2-3 |
| Rheology modifier | 0-2 | 0.5-1.5 |
| Flavoring Agent | 0-0.5 | 0-0.2 |
| Bittering Agent | 0-0.05 | 0.002-0.003 |
| Diluent | 0-40 | 10-30 |

As described in Table 1, the essential components of the paint and varnish remover composition of the invention include synergistic mixed solvents: NMP/BLO (available from commercial sources) which are activated by ethyl 3-ethoxypropionate (EEP). The activator compound EEP is available from Eastman Chemicals as Ektapro® EEP solvent. The presence of EEP in the composition activates the solvents so that more effective paint and varnish removal action is achieved. Since EEP reduces the flash point of the composition, which is not desirable, it is preferred to use the lower end of the suitable range of the activating effect of EEP. NOP, ALC EO, and SILWETT L 77 are also available from commercial sources.

The composition of the present invention may contain optionally, one or more of the group of a surfactant, a thickener, a fragrance, a bittering agent and a diluent. Suitable surfactants include non-ionic surfactants with HLB ranging from about 8-18, selected from:
1. The polyethylene oxide condensates of alkylphenols, e.g., the condensation products of alkylphenols or dialkyl phenols wherein the alkyl group contains from about 6 to about 12 carbon atoms in either branched chain or particularly straight chain configuration, for example, octyl cresol, octyl phenol or nonyl phenol, with ethylene oxide, the said ethylene oxide being present in amounts equal to about 5 to about 25 moles of ethylene oxide per mole of alkylphenol.
2. Partial esters formed by the reaction of fatty acids, for example of about 8 to about 18 carbon atoms, with polhydric alcohols, for example, glycerol, glycols, such as, mono-, di-, tetra- and hexaethyleneglycol, sorbitan, etc.; and similar compounds formed by the direct addition of varying molar ratios of ethylene oxide to the hydroxy group of fatly acids.
3. The condensation products of fatty acid partial esters with ethylene oxide, such as fatty acid esters of polyoxyethylene sorbitan and sorbitol containing from about 3 to about 80 oxyethylene units per molecule and containing fatty acid groups having from about 8 to about 18 carbon atoms.
4. The condensation products of aliphatic alcohols having from about 8 to about 18 carbon atoms in either straight chain or branched chain configuration for example, oleyl or cetyl alcohol, with ethylene oxide, the said ethylene oxide being present in amounts equal to about 30 to about 60 moles of ethylene oxide per mole of alcohol.

Examples of surface active agents which may be used are those supplied under the following trade names with approximate Chemical Constitution:
Antaron® monocarboxyl cocoimidazoline
Igepon® alkyl sulfoamides
Alipal® ammonium salt of ethoxylate sulfate
Igepal® ethoxylated alkylphenol
Emulphogene®
tridecyloxypoly(ethyleneoxy)ethanol
Span 40® sorbitan monopalmitate
Parasyn® hydrogenated castor oil
Miraniol®
cocoamphodipropionate
Trydet® polyethoxylated fatty acid ester

Suitable organic acids include but not limited to Formic acid, Sulfonic acid (alkyl sulfonic acid), aryl sulfonic acid, alkyl/aryl phosphonic acid. It is preferred to use strong acids for most effectiveness, preferred pKa 2-3, preferably <3.

Thickeners may also be included in the inventive composition. The preferred thickeners or gelling agents are cellulose derivatives which have the property of both water and organic solvent solubility. Cellulose derivatives of this type which are of particular interest are those ether derivatives containing etherifying groups selected from hydroxyalkyl groups and groups derived therefrom, such etherifying groups containing preferably up to about 5 or 6 carbon atoms. The gelling agent may also comprise cellulose ether derivatives which, in addition to etherifying groups selected from hydroxyalkyl groups and groups derived therefrom, contain other types of etherifying groups, especially small alkyl groups of, for example, one or two carbon atoms. However, such etherifying groups generally confer properties upon the cellulose derivative which are less acceptable for the present purpose, and the gelling agent is therefore conveniently substantially restricted to cellulose ether derivatives containing etherifying groups selected from hydroxyalkyl groups and groups derived therefrom.

Etherifying groups consisting of or derived from hydroxyalkyl groups containing up to 5 carbon atoms, particularly, 2, 3 or 4 carbon atoms, are of especial value. The hydroxypropyl celluloses, for example, have been found to be of particular value in giving a substantially transparent gel system with a suitable solvent system and in imparting quite adequate thickening and film-forming properties in their own right without the need of any other agents for these purposes. Conveniently, the hydroxypropyl group in such celluloses is derived from isopropanol rather than n-propanol but a number of variations in structure are possible even when this is the case. Thus, not all of the free hydroxy groups of the cellulose need necessarily be substituted and, if desired, the hydroxy groups of certain hydroxypropyl groups may, in turn, be substituted by a further hydroxypropyl group (as for example, in the Klucel® materials described below). Hydroxypropyl celluloses employed in compositions according to the present invention conveniently have molecular weights in the range from about 50,000 to about 1,000,000, preferably from about 800,000 to 1,000,000.

One form of hydroxypropyl cellulose which has been used with advantage is marketed under the trade name Klucel H. Klucel® H has a similar chemical structure to Klucel® MS 3.0, which may also be used, but is of higher molecular weight, and possesses particular advantages in terms of the viscosity of its solutions. Thus, a 1% solution of Klucel® H in water has a viscosity in the range from 1,500 to 2,500 units and in ethanol the range is 1,000 to 2,500 units while solutions of Klucel® MS 3.0, particularly in ethanol, have a lower viscosity. The property of possessing a substantially similar viscosity in organic solvent and aqueous solutions is a valuable one for gelling agents used in compositions according to the present invention. The proportion of gelling agent required in the compositions in order to give good gels, depends in part on the molecular weight of the gelling agent used, the usual range being from 0.25% to 2%. Thus, for example, with the usual proportion of gelling agent of from about 0.25% or 0.5% u pwards is suitable for high molecular weight materials and of from about 2% upwards is suitable for low molecular weight materials. For high molecular weight materials, for example of molecular weights of 800,000 to 1,000.000, a proportion of above 1.5% is preferably avoided as it leads to a gel of too great a viscosity. With low molecular weight materials, larger proportions may be used before such a position is reached and, if the molecular weight is low enough, amounts of up to 10% or even 20% or more may be used. It will be appreciated, however, that the use of a smaller amount of material of higher molecular weight is generally to be preferred.

A typical fragrance is oil of wintergreen (methyl salicylate) although many others known in the art may be used as well.

Suitable diluents include organic hydrocarbons such as dipentene and xylene, alkylene glycol ethers such as propylene glycol monomethyl ether, tripropylene glycol monomethyl ether, dipropylene glycol monomethyl ether and tetrahydrofurfuryl alcohol, and propylene carbonate. Mixtures of these compounds also may be used. A suitable bittering agent is denatonium benzoate although others known in the art may be used as well.

Representative compositions of the invention include the following Examples below:

TABLE 3
Typical paint stripping compositions (non-volatile components)

| | | | | | |
|---|---|---|---|---|---|
| NMP or Solvent A/B/C/D/E | 30-40 | 40-50 | 0 | 10-20 | 30-40 |
| BLO or Solvent A/B/C/D/E | 50-60 | 0 | 50-60 | 20-30 | 20-30 |
| Polar solvent 3 | 0 | 30-40 | 30-40 | 30-40 | 10-20 |
| A through A/B/C/D/E | | | | | |
| EEP | 3-4 | 3-4 | 3-4 | 3-4 | 3-4 |
| Emulphogene ® DA-630¹ | 2-3 | 2-3 | 2-3 | 2-3 | 2-3 |
| Oil of Wintergreen/Thymol | 0.2-0.3 | 0.2-0.3 | 0.2-0.3 | 0.2-0.3 | 0.2-0.3 |
| Denatonium benzoate | 0.002-0.003 | 0.002-0.003 | 0.002-0.003 | 0.002-0.003 | 0.002-0.003 |
| Klucel ® H | 1.15-1.35 | 1.15-1.35 | 1.15-1.35 | 1.15-1.35 | 1.15-1.35 |
| NOP | 1-1.5 | 1-1.5 | 1-1.5 | 1-1.5 | 1-1.5 |
| Silwett L 77 | 0.5-1 | 0.5-1 | 0.5-1 | 0.5-1 | 0.5-1 |

including optional ingredients (NEW)

### EXAMPLES

### Identity of Solvents A through E are described in Terms Hansen Polar Components

NOP can be replaced by alcohol ethoxylates (ALCEO) or commercial Easy Wet 20 (polyoxyethylated (6) decyl alcohol)

Methodology used to determine the relative efficacy of treatment compositions was extracted from U.S. Pat. No. 5,098,5920 (Incorporated herein by reference in its entirety):

In preliminary screening, one drop of test formulation was applied to 24-inch-long, ½ inch high, and 3 inch wide panels of pine wood painted liberally with 3 coats of alkyd enamel paint and cured in air for 1 week and in an oven for 2 days at 50° C. The spots containing the reagents were scrapped at 15 minute and 30 minute intervals and the relative paint stripping performance measured in terms of number of coats removed, 3 being perfect by visual evaluation.

The efficacy test results is carried out on 12 whole panels of wood inter-painted with 4 coats of air cured paint and varnish:materials for 8-24 hours. The effectiveness is measured as the percentage of the 4 coats removed after 30 minutes of stripping time with brush application of sufficient test material to cover the surface completely. The coating for the panels is as follows:
Panel 1: Glidden, acrylic latex-white,
Panel 2: Red Devil; acrylic enamel-brown,
Panel 3: Rickel Alkyd enamel-white,
Panel 4: Pittsburgh semigloss latex-white,
Panel 5: Glidden exterior gloss latex-black,
Panel 6: Rickel latex trim exterior gloss-green,
Panel 7: Modern floor deck enamel interior-exterior brown,
Panel 8: Muralo, acrylic midgloss-white,
Panel 9: Muralo, vinyl-acrylic latex-pink,
Panel 10: Mcloskey gloss polyurethane varnish clear,
Panel 11: Red Devil, gloss polyurethane-enamel-blue,
Panel 12: Sears, interior-exterior latex enamel high gloss-purple.
   While the compositions herein have been shown are formulated as solutions, it will be understood that other forms of the inventive compositions may be used as well, such as aerosol sprays, gels, lotions, creams etc.

### EXAMPLES

### Example 1

Commercial paint stripping compositions, Zipstrip containing Methylene Chloride as the major component is used to strip typical 24-inch-long, ½ inch high, and 3 inch wide panels of pine wood painted with 3 coats of alkyd enamel paint/Latex semigloss paint/varnish and cured in air for 1 week and in an oven for 2 days at 50° C. as described below. A liberal amount of Zipstrip is applied by a brush and left in the hood for 15 minutes. The softened paint/varnish is removed by a scrapper. The process is repeated a second time. Average Paint removed in the first step and second step was 70% and 90-100% respectively.

### Example 2

Example 1 is repeated using the commercial stripper mixed (zipstrip) with 10% inventive composition summarized in Table 3 using Polar solvents A and B (Column 2) Results were better than in Example 1. Less time is required in removing all layers of paint. No residual deposition is found. Total stripping composition required is about 20% less as measured by total weight of paint striping composition/area treated,

### Example 3

Example 1 was repeated using the commercial stripper mixed with 10% inventive composition summarized in Table 3 using Polar solvents B and D (Column 2)

Results were better than in Example 1. Less time is required in removing all layers of paint. No residual deposition is found. Total stripping composition required is about 20% less as measured by total weight/area treated.

### Example 4

An old metal garage door [˜8×7 ft] with 10+years old paint is used to strip the paint using commercial paint stripper, ZIPSTRIP. Half the door is treated with Zipstrip. After 15 minutes of standing, the loosened paint is stripped off, redeposited paint coating is observed. The same surface is retreated with the commercial ZIPSTRIP, and let stand for 15 minutes. After the second treatment, II the paint is stripped off. The surface is cleaned using ethanol to wipe off. The treatment required half quart of the zipstrip.

### Example 5

Example 4 is repeated using the untreated half of the garage door. In this experiment, Zip strip is mixed with 20% of the inventive composition summarized in Table 3 using Polar solvents NMP and BLO (Column 2). A single treatment with 15 minutes standing removed practically all the paint. The residual is washed with water. This treatment used approximately half the paint stripping composition as above compared with the commercial paint striper Zipstrip.

8. A composition for the removal of paint or varnish from wood or metal surfaces consisting essentially of about 20-70% by weight of an ester amide, about 30-80% by weight of gamma-butyrolactone, and about 1-30% by weight of ethyl 3-ethoxy propionate.

9. The composition of claim 8 wherein the amount of ethyl 3-ethoxy propionate is about 2 to 15% by weight.

10. (canceled)

11. The composition of claim 8 wherein the amount of ester amide is from about 30 to 65% by weight, the amount of gamma-butyrolactone is about 35 to 70% by weight and the amount of ethyl 3-ethoxy propionate is from 2 to 15% by weight.

12. The composition of claim 8 wherein the amount of ester tide is from 35 to 39% by weight, the amount of gamma-butyrolactone is 55 to 59% and the amount of ethyl 3-ethoxy propionate is from 3 to 5% by weight.

13. The composition of claim 8 wherein the amount of ester amide is 37%, the amount of gamma-butyrolactone is 57% and the amount of ethyl 3-ethoxy propionate is 3.5%.

14. (canceled)

15.The composition of claim 8 which include about 2.5% by weight of surfactant, about 1.2% by weight of thickener, about 0.25% by weight of a flavoring agent, and about 0.0025% by weight of a bittering agent.

16. The composition of claim 8 which further includes about 35 to 39% by weight ester amide, 55 to 59% by weight of gamma-butyrolactone, 3 to 5% by weight of ethyl 3-ethoxy propionate, 2 to 3 by weight poly oxyethylene-6-decyl alcohol, 0.2 to 0.3% by weight methyl salicylate, 0.002 to 0.003% by weight denatonium benzoate and 1.15 to 1.35% by weight hydroxypropyl cellulose.

17-19. (canceled)

20. The composition of claim 8 which further comprises a compound selected from the group consisting of surfactants, thickeners flavoring agents, bittering agents diluents and mixtures thereof.

21. The composition of claim 20 wherein the composition consists essentially of about 30-65% by weight of an ester amide, about 35 to 70% by weigh t of gamma butyrolactone, and about 2 to 15% by weight of ethyl 3-ethoxy propionate.

22. The composition of claim 20 wherein the composition consists essentially of about 35 to 39% by weight of an ester amide, about 55 to 59% by weight of gamma-butyrolactone, and about 3 to 5% by weight of ethyl 3-ethoxy propionate.

23. The composition of claim 20 wherein the amount surfactant is about 5% by weight, the amount of thickener is up to about 2% by weight, the amount of flavoring agent is up to about 0.5% by weight, the amount of bittering agent is up to about 0.04% by weight, and the amount of diluent is up to about 40% by weight.
